(19) United States
(12) Patent Application Publication
(10) Pub. No.: US 2024/0300177 A1
(43) Pub. Date: Sep. 12, 2024

(54) MATERIAL PREPARATION AND FEEDING SYSTEM OF A CONSTRUCTION 3D PRINTER

(71) Applicant: AC3D, INC., San Francisco, CA (US)

(72) Inventors: Dmitrij Konshin, Balashiha (RU); Boris Kozlov, Moscow (RU)

(21) Appl. No.: 18/691,883

(22) PCT Filed: Jul. 15, 2022
(86) PCT No.: PCT/RU2022/050224

§ 371 Date: Mar. 13, 2024

(30) Foreign Application Priority Data
Oct. 1, 2021 (RU) 2021128769

(51) Int. Cl. B29C 64/336; B29C 64/209; B29C 64/314; B33Y 30/00

(52) U.S. Cl. CPC B29C 64/336; B29C 64/209; B29C 64/314; B33Y 30/00

(57) ABSTRACT

A system for preparing and feeding the material of a construction 3D printer comprises a housing including two cavities connected by a finished mixture feeding channel: a mixing cavity with a mixing roller and a feeding cavity with a feeding roller. A mixing roller is designed to rotate using its own drive; it is a cylinder with two functional elements installed on it: a mixing element and a feeding element. A feeding roller is designed to rotate using its own drive; and it is a rotor of the gerotor pair; and the axes of the mixing and feeding rollers are mutually perpendicular. A dry powder mixture feeding cyclone is connected to the mixing cavity, which is connected to the dry mixture feed channel and the liquid feed channel, an alternative nozzle with its own drive is installed at the outlet of the feed cavity.

### TECHNICAL FIELD

The invention relates to the construction field, namely to the printing head of a construction 3D printer serving as a compounding extruder, as well as to construction multi-material additive manufacturing for the purpose of producing building structures; and can be used for the construction of residential houses, buildings and structures for various purposes, manufacturing parts and elements of buildings, reinforced concrete products, parts of building structures made from concrete or other building mixtures.

### TECHNICAL LEVEL

The 3D printer print head is known from the prior art (see Ref. [1] Russian Federation patent for utility model No. 179153, IPC E04G 21/16, B41J 2/335, publ. 28, Apr. 2018); it consists of a nozzle and a compounding extruder connected thereto, which includes a body, an auger containing cylindrical and conical parts, valves for feeding individual components of the mixture and a drive of the auger.

The disadvantage of this analog is that mixing and feeding of the material is carried out by a single working organ—an auger. The mixture will need more time to mix well enough and to be fed in a sufficiently finished form. In addition, the auger is not an efficient mixing device. Besides, it is not possible to adjust the mixing and feeding speeds separately.

A construction 3D printer extruder is known from the prior art (cf. [2] Russian Federation patent for utility model No. 185166, IPC E04G 21/04, B41J 2/335, B29C 47/10, published 23 Nov. 2018); it contains a print head connected by means of a mix feed mechanism drive to its motor and an auger, a surface forming device mounted on the print head, a fixing mechanism mounted on the mix feed mechanism drive, connecting a fixed mix feed tube linked thereto and a sealed connection to which a mix feed tube located inside the mix feed mechanism drive is connected that is rotating with it and the auger, on which mix feed nozzles are mounted.

The disadvantage of this variant is that the mixture is fed to the head in dissolved form. In case of this feeding system, the mixture cannot be thick enough, that is a necessary parameter in construction printing. There are also difficulties in maintaining the printer. If the feed is stopped, the entire feed system must be cleaned quickly and efficiently, otherwise there is a risk of failure after the residual mix solidifies inside the system.

A construction compound extruder for a 3D printer is also known from the prior art (cf. [2] Russian patent for invention No. 2724163, IPC B29C 64/209, published 22 Jun. 2020); it consists of a container with a mounting device allowing to fix the extruder on the printer actuators, an opening for loading the construction material, a nozzle with an outlet opening for extruding the construction material, wherein a construction mixture dispenser is integrated into the lower part of the container, allowing to regulate the amount of the construction mixture when forming the printed layer, and the extruder contains a sub-mixing device in the form of a sub-mixing frame with an actuator, which is at the same time serves as a drive unit. The building mixture dispenser may be made in the form of an auger or a gerotor pair.

The main disadvantage of this analog is that the mixture is fed to the head already in dissolved form. In comparison to analog [2] in variant [3] it is possible to change the composition of the mixture by adding various additives through additional supply lines made in the form of a connector. However, this solution will allow changing the composition of the initially supplied mixture insignificantly. Difficulties also arise when servicing the printer. If the feed is stopped, the entire feed system must be cleaned quickly and efficiently, otherwise there is a risk of failure after the residual mix solidifies inside the system.

The closest analog, taken as a prototype, is a mixer used for making a structure from a building material (see Ref. [4] Russian invention U.S. Pat. No. 2,735,761, IPC B01F 7/08, B01F 7/18, B01F 15/02, B28C 5/12, published 6 Nov. 2020), containing a drum having at least one inlet and one outlet, a drive, a mixing roller located in the drum and connected to the drive, wherein the drum contains a conveying device located on the same axis as the mixing roller, and the conveying device is directly adjacent to the mixing roller, which allows to be capture material directly by the conveying device and discharge it from the drum through the outlet.

The disadvantages of the prototype are, firstly, the impossibility to lock the mixture at the outlet of the feeding device (when the screw stops, the mixture will continue to flow into the outlet). Secondly, the mixture goes out randomly, i.e. there is no molding of the mixture at the outlet of the conveying device. Thirdly, the main disadvantage of the prototype is the lack of the possibility of making the mixture, because the mixer receives the ready mixture from the mixing device and there is a possibility of feeding two components, i.e. this mixer only mixes the ready mixture and components.

The disadvantages of the known analogs are the following:
1. In fluid feeding systems (when the compound is prepared in an external mixer and fed to the print head through long hoses) the consistency of the mixture is not fully suitable for 3D printing, due to the need to ensure certain rheological properties of the ready mixture for its ability to be supplied through hoses into the extruder;
2. The necessity to clean the entire system of fluid mixture feeding every time work stops to avoid its solidification in the system and, accordingly, a high probability of equipment failure;
3. Difficulty in controlling the mixture pressure within the distance from the pump to the extruder and, as a consequence, difficulty in controlling the homogeneity of layer thickness and surface quality when using fluid feed;
4. Another common approach that is also inefficient is absence of a material transport system in a 3D printer; i.e. only manual (e.g., using a shovel) addition of the mixture into a hopper located directly on the print head. This approach significantly increases the weight and size of the print head, and adds the need for constant manual refilling of the mix hopper capacity;
5. In existing mixing systems, where the mixing and feed rollers have a single drive, it is not possible to control the mixing and feed speeds separately;
6. Available faucet layouts are not suitable for use in 3D printer designs;
7. There is no system for molding the mixture at the output of the mixers.

### Character of Invention

The task of the claimed invention is to eliminate the disadvantages of analogs and prototype, as well as the possibility of preparation and dry mixture feeding of the material, in which the components are mixed immediately before extrusion, by providing quality mixing and controlled feeding of the mixture with its subsequent molding during extrusion, which allows to increase the speed and quality of printing, as well as the possibility of using more viscous mixtures, which as a consequence allows to obtain better quality products. Such mixtures harden faster and hold their shape better.

The technical result is to increase the efficiency of mixing the compound, increase the speed and quality of printing.

A system for preparing and feeding the material of a construction 3D printer consisting of a housing including two cavities connected by a finished mixture feeding channel (a mixing cavity with a mixing roller and a feeding cavity with a feeding roller) is offered to address the issue and achieve the stated technical result. A mixing roller is designed with a possibility to rotate using its own drive; it is a cylinder with two functional elements installed on it: a mixing element and a feeding element. A feeding roller is designed with a possibility to rotate using its own drive; and it is a rotor of the gerotor pair; and the axes the mixing and feeding rollers are mutually perpendicular. A dry powder mixture feeding cyclone is connected to the mixing cavity, which is connected to the dry mixture feed channel and the liquid feed channel, a replaceable nozzle with its own drive is installed at the outlet of the feed cavity.

And the technical result is accomplished due to the fact that the mixing elements are made in the form of blades and/or pins located perpendicular to the axis of the mixing roller.

Besides, the technical result is achieved by the fact that the pins are L-shaped or U-shaped.

And the technical result is also achieved due to the fact that the feeding element is designed in the form of at least two auger flights.

### BRIEF DESCRIPTION OF DRAWINGS

FIG. 1—Schematic representation of the feed system

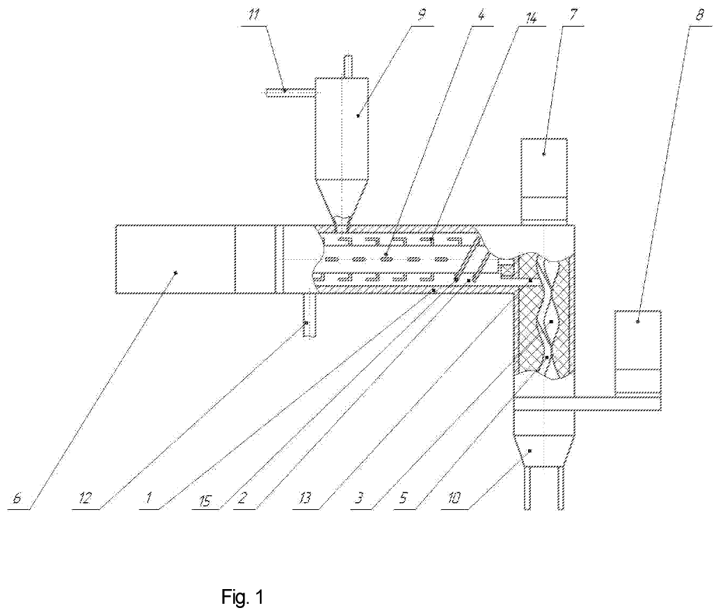

The FIGURE is labeled with the following positions: 1—housing; 2—mixing cavity; 3—feeding cavity; 4—mixing roller; 5—feeding roller; 6—mixing roller drive; 7—feeding roller drive; 8—alternative nozzle drive; 9—cyclone; 10—alternative nozzle; 11—dry mixture feed channel to the cyclone; 12—liquid feed channel to the mixing cavity; 13—channel of ready mixture supply from the mixing cavity to the feeding cavity; 14—mixing elements of the mixing roller; 15—feeding elements of the mixing roller.

### EXERCISE OF INVENTION

The material preparation and feeding system of a construction 3D printer (construction 3D printer print head or compound extruder) consists of a housing (1), including two cavities: a mixing cavity (2) and a feeding cavity (3). The cavities (2) and (3) are interconnected by a finished mixture feed channel (13). There is a mixing roller (4) in the mixing cavity (2); and there is a feeding roller (5) in the feeding cavity (3).

The mixing roller (4) is designed with a possibility to rotate using its own drive (6) and comprises a cylinder with two functional elements mounted thereon: a mixing element (14) and a feeding element (15). The mixing elements may be designed in the form of blades and/or pins (14) arranged perpendicular to the axis of the mixing roller (4). The pins may be made in any shape, including L- or U-shapes. The feeding element (15) can be made in the form of feed vanes or at least two auger flights, which ensures the capture of the ready mixture from the mixing cavity (2) and its feeding through the channel (13) into the feeding cavity (3).

The feeding roller (5) is designed with the possibility to rotate using its own drive (7) and represents a rotor of the gerotor pair, which performs extrusion of the finished mixture. Use of the gerotor pair rotor provides locking of the mixture in case the drive (7) stops; and thus excludes its leakage, which increases the quality of the printed structure.

The separate drives (6) and (7) allow flexible adjustment of the speed of the rollers (4) and (5) rotation, which provides flexible adjustment of the speed of mixing of the mixture and its extrusion separately from the cavities (2) and (3).

The axes of the mixing roller (4) and the feed roller (5) are mutually perpendicular, which is the most space effective variant for the layout of the 3D printer print head.

A cyclone (9) for supplying dry powder mixture is connected to the mixing cavity (2), which is connected to a channel (11) for feeding dry mixture. A fluid feeding channel (12) is also connected to the mixing cavity (2). The liquid may include water with necessary additives. The fluid feeding channel (12) may be located at the bottom, top or side of the mixing cavity (2). The fluid feeding channel (12) may be performed through a high or low pressure nozzle.

In order to give the mixture a regular shape during extrusion, there is a hollow alternative nozzle (10) with its own drive (8), which rotates the nozzle through, for example, a belt or gear or other transmission, in accordance with the direction of laying the layer of mixture. The mixture, passing through the nozzle, takes a shape determined by the geometry of this nozzle. The nozzles may have differently shaped openings for the exit of the mixture and elements for forming the side and top surfaces of the layer.

The presented design solves the problems of convenient placement of the dry feeding elements of the print head, provides efficient mixing, and also provides separately flexibly adjustable modes of mixing and feeding of the mixture, formation of the layer of the extruded mixture, which increases the efficiency of mixing, the quality of printed structures and printing speeds. Dry feeding allows using more viscous mixtures during printing, which, as a consequence, allows obtaining higher quality products. Such mixtures harden faster and hold their shape better.

### EXAMPLE EMBODIMENT OF THE INVENTION

A mixture of material (for example, based on lime, gypsum, cement or combinations thereof) in dry powdered form is fed by a pneumatic chamber pump through a channel (11) into a cyclone (9) and further into a mixing cavity (2). The cavity (2) is also supplied with liquid (water with necessary additives dissolved in it) through the channel (12).

The ingredients fed into the area (2) are further mixed by the elements (14) by rotating the roller (4) with the help of the drive (6) to a homogeneous mass. By means of feeding elements (15) the ready mixture is pushed into the feeding area (3). By rotation of the gerotor pair rotor of the feeding roller (5), the ready mixture is extruded from the feeding system with the formation of the required layer due to the alternative nozzle (10), equipped with its own drive 8.

1. A system for preparing and feeding the material of a construction 3D printer, comprising:
a housing with two interior cavities, a first cavity being a mixing cavity and a second cavity being a feeding cavity, the two interior cavities being connected by a channel for feeding a ready mix;
a mixing roller installed in the mixing cavity,
a feeding roller installed in the feeding cavity;
wherein the mixing roller is configured to rotate using a drive of the mixing roller;
wherein the mixing roller is a cylinder with a mixing element and a feeding element being mounted thereon;
wherein the feeding roller is configured to rotate using a drive of the feeding roller;
wherein the feeding roller is a rotor of a gerotor pair;
wherein axes of the mixing roller and the feeding roller (5) mutually perpendicular;
wherein the mixing cavity is connected to a cyclone separator configured to fee a dry powder mix, the cyclone separator being connected to a dry mixture feed channel, and a liquid feed channel;
wherein an alternative nozzle with its own drive is installed at an outlet of the feeding cavity.

2. The system according to claim 1, wherein the mixing blades and/or pins arranged perpendicular to an axis of the mixing roller.

3. The system according to claim 2, wherein the pins are L-shaped or U-shaped.

4. The system according to claim 1, wherein the feed element comprises at least two auger flights.
